(19) United States
(12) Patent Application Publication
(10) Pub. No.: US 2010/0097266 A1
(43) Pub. Date: Apr. 22, 2010

(54) SINGLE PLATFORM PASSIVE COHERENT LOCATION USING A DIGITAL RECEIVER

(75) Inventor: James A. Johnson, Owego, NY (US)

Correspondence Address: Lockheed Martin Corporation;c/o WOLF, GREENFIELD & SACKS, P.C., 600 ATLANTIC AVENUE, BOSTON, MA, 02210-2206, US

(73) Assignee: Lockheed Martin Corporation, Bethesda, MD (US)

(21) Appl. No.: 12/255,277

(22) Filed: Oct. 21, 2008

(51) Int. Cl. G01S 13/00

(52) U.S. Cl. 342/195

(57) ABSTRACT

A system and method for performing passive coherent location (PCL). A PCL radar system has high speed analog-to-digital converters (ADC) for digitizing RF signals received on antenna elements of an antenna array. The RF signal received by each antenna element is processed by components within a corresponding physical channel. The RF signals are digitized by the high speed ADC and then processed by a frequency channelizer. The frequency channelizer inputs the RF signal into a digital filter bank comprising a plurality of band pass filters. Each filter in the filter bank may have a corresponding filters, which share the same filtering properties, in the frequency channelizers of each of the physical channels. The outputs of such corresponding filters share a frequency channel. Beam forming and PCL processing are performed for each frequency channel on the filter outputs from each physical channel sharing said frequency channel. A target state is estimated.

### BACKGROUND

1. Field of the Invention

The invention relates generally to the field of passive coherent location (PCL).

2. Description of Related Art

Passive Coherent Location (PCL) is a bistatic or multistatic radar system, principally having a PCL receiver and one or more transmitters. Frequently, PCL radar systems rely on uncontrolled transmitters (i.e., emitters of opportunity), such as TV and FM radio transmitters, rather than deployed transmitters. By avoiding the need to broadcast, costs associated with PCL radar systems are considerably lower than a comparable conventional radar system.

PCL radar systems rely on radiation provided by remotely located transmitters at known locations. A portion of the radiation, known as the reference or direct path signal, is received directly from the transmitter. Another portion of the radiation, known as the scattered signal, is reflected from radar targets and received by the PCL receiver. The PCL receiver uses the direct path signal and the scattered signal to determine various properties of the target from which the scattered signal was reflected.

FIG. 1 shows a diagram of an exemplary PCL radar system scenario. This example scenario has a target 100, transmitters 110, 120, and 130, and PCL receiver 200. Each transmitters emits electromagnetic radiation such as ambient transmissions 111 and 112 radiated from transmitter 110. Ambient transmission 111 is received directly by the PCL receiver 200. Ambient transmission 112 is scattered by target 100 and scattered transmission 113 is received by PCL receiver 200. The received portions of ambient transmission 111 and scattered transmission 113 serve as the reference and scattered signal, respectively. The reference signal may be orders of magnitude greater than scattered signal. PCL receiver 200 compares the reference signal and the scattered signal to determine information about target 100. Transmitters 120 and 130 may be used similarly.

### SUMMARY

Methods and apparatus for performing passive coherent location (PCL).

In some aspects, the invention relates to a passive coherent location radar comprising a plurality of antenna elements, a plurality of analog-to-digital converters, and a plurality of frequency channelizers. Each antenna element outputs an RF signal. Each analog-to-digital converter is configured to receive the RF signal from a corresponding antenna element among the plurality of antenna elements, and output a digital signal, the digital signal being a digital version of said RF signal. Each frequency channelizer has a plurality of digital band-pass filters and configured to receive the digital signal from a corresponding analog-to-digital converter among the plurality of analog-to-digital converters, input the digital signal to each of the plurality of digital band-pass filters, and output a plurality of filtered signals, each filtered signal output from a digital band-pass filter among the plurality of digital band-pass filters.

In another aspect, the invention relates to a method of operating a passive coherent location radar system. The method comprising receiving an RF signal on each of a plurality of antenna elements, each antenna element corresponding to a physical channel; digitizing each RF signal; filtering each digitized RF signal with a plurality of digital band-pass filters, each digital band-pass filter corresponding to a frequency channel; determining a frequency-difference of arrival (FDOA) with respect to a corresponding reference signal for each filtered signal; and estimating a target state from the corresponding FDOA from each physical channel for each frequency channel.

In yet another aspect, the invention relates to a radar system comprising a physical channel and a processing unit. The physical channel comprises an antenna that outputs an RE signal; an amplifier configured to amplify at least a portion of the RF signal; an analog-to-digital converter configured to digitize the amplified RE signal; and a digital filter bank comprising a plurality of pass-band filters configured to receive the digitized RE signal and output a plurality of digital band-passed signals. The processing unit is configured to receive a digital band-passed signal, from the plurality of digital band-passed signals, output from a pass-band filter among the plurality of pass-band filters and estimate a target state.

### BRIEF DESCRIPTION OF DRAWINGS

The invention and embodiments thereof will be better understood when the following detailed description is read in conjunction with the accompanying drawing figures. In the figures, elements are not necessarily drawn to scale. In general, like elements appearing in multiple figures are identified by a like reference designation. In the drawings:

FIG. 1 illustrates a bistatic passive coherent radar scenario as was known in prior art;

FIG. 2 is a block diagram of a passive coherent location radar system according to an embodiment of the invention;

FIG. 3 is a block diagram of a passive coherent location radar system according to another embodiment of the invention;

FIG. 4A-E are illustrations of antenna configurations;

FIG. 4F provides a reference coordinate system for FIGS. 4A, 4C, and 4E; and

FIG. 5 is a method of operating a passive coherent location radar system according to an embodiment of the invention.

### DETAILED DESCRIPTION

A passive coherent location (PCL) radar system is presented that utilizes a high speed, analog-to-digital converter (ADC) and a frequency channelizer. Direct path and scattered signals received from emitters of opportunity (e.g., TV and FM broadcasts) may be converted to the digital domain without analog spectral shifting.

The ADC has a very high Nyquist frequency, greater than 500 MHz in some embodiments, that enables capture of signals originating from many different types of transmitters to be captured (e.g., TV, FM, GSM). Each antenna may simultaneously capture signals from multiple transmitters broadcasting in different frequency bands. After analog-to-digital (A/D) conversion of the received RF signal, a digital filter bank, having a number of band pass filters, may be used to channelize the received signals. Each band-pass filter may correspond to a band of one of the uncontrolled transmitters (i.e., emitters of opportunity). The filtered signals may be processed to estimate target states.

### PCL Radar System 200

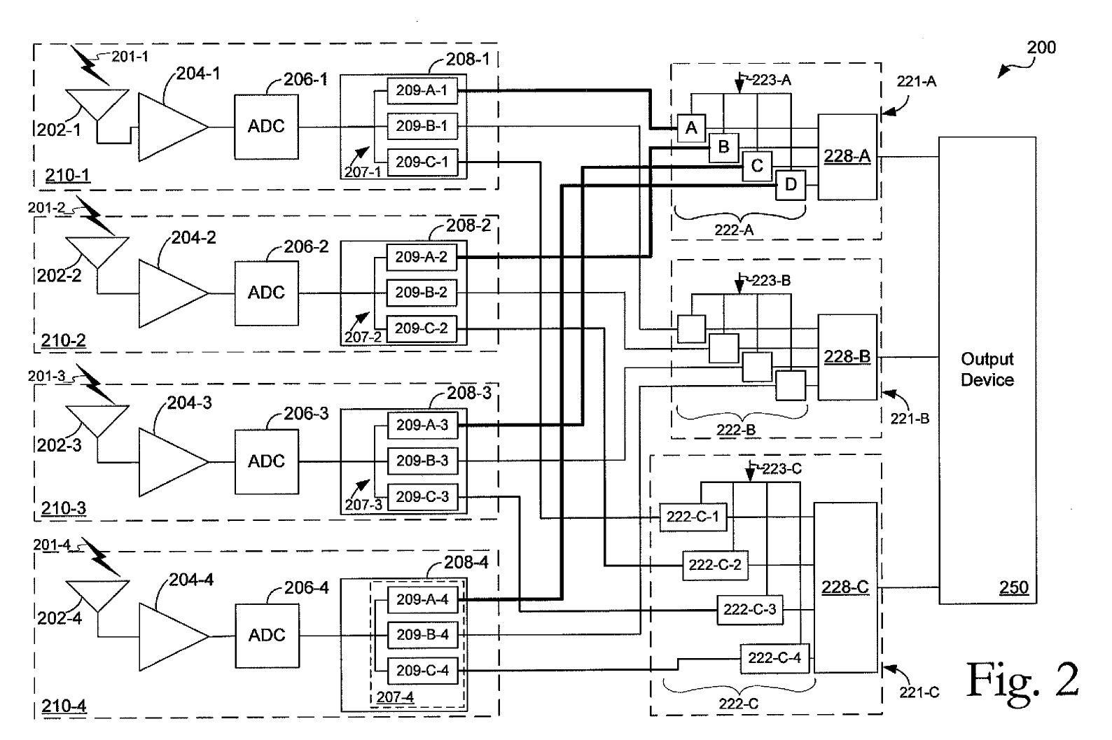

An embodiment of the architecture for PCL radar system 200 is shown in FIG. 2. The PCL radar system 200 includes a number of physical channels 210-i (i=1, 2, 3, 4) corresponding to the number of antenna elements in the PCL radar system's antenna array. The antenna element 202-i, conditioner 204-i, ADC 206-i and frequency channelizer 208-i, are components of a physical channel 210-i. Physical channels 210-i contain the hardware to receive and process the RF signals 201-i received on their respective antenna elements 202-i prior to the combining the signals from the elements of the array. In this example, the antenna array is made up of four antenna elements 202-i (i=1, 2, 3, 4), however, any number of antenna elements may be used.

The RF signal 201-i received and output from each antenna 202-i is amplified and conditioned by the signal conditioner 204-i. The signal conditioner may optionally perform analog band-pass filtering, or perform up or down conversion using an analog mixer.

The conditioned signal is then digitized by ADC 206-i. ADC 206-i produces a digital version of the analog RF signal.

The digitized signal is received by frequency channelizer 208-i, Frequency channelizer 208-i has a digital filter bank 207-i having a number of digital band-pass filters (e.g., band-pass filters 209-A-i, 209-B-i, and 209-C-i). The pass-band filters may be used to provide channel equalization or conditioning as well as bandwidth reduction. In this example, three band-pass filters are illustrated in each filter bank. The filter bank of a frequency channelizer, however, may have any number of band-pass filters.

In some embodiments, the filter banks of each frequency channelizer may be identical or similar in each physical channel. A frequency channel is shared by the signals output from pass-band filters having the same, or similar, filter characteristics (e.g., center frequency, bandwidth). In some embodiments, each physical channel provides a signal on a frequency channel. For example, the signals sharing a frequency channel (e.g., 103.2 to 103.4 MHz) may each correspond to the scattered signal received by the respective antenna elements for a common transmission source (e.g., FM radio station 103.3). In the example embodiment, each of band-pass filters 209-A-1, 209-A-2, 209-A-3, and 209-A-4 has the same passband characteristics and thus the outputs correspond the same frequency channel. Similarly, pass-band filters 209-B-i (i=1, 2, 3, 4) may correspond to another frequency channel, and filters 209-C-i (i=1, 2, 3, 4) may correspond to yet another frequency channel.

In some embodiments, the filter banks of each physical channel have the same (or sufficiently similar) filter characteristics and signals from different physical channels, filtered by band-pass filters having the same passband, may be processed together.

Filtered output signals sharing the same frequency channel are processed by the same PCL processing unit 221-X (X=A, B, C). In the example embodiment of PCL radar system 200, there are three band-pass filters in each filter bank, and there are three corresponding PCL processing units. The outputs of band-pass filters 209-A-i, 209-B-i, and 209-C-i are output to PCL processing units 221-A, 221-B, and 221-C, respectively.

Each PCL processing unit 221-X has a parametric estimation bank 222-X and a parameter estimator 228-X. The parametric estimation bank 222-X has a number of parametric estimators. The parametric estimators 222-C-i are labeled explicitly for parametric estimation bank 222-C.

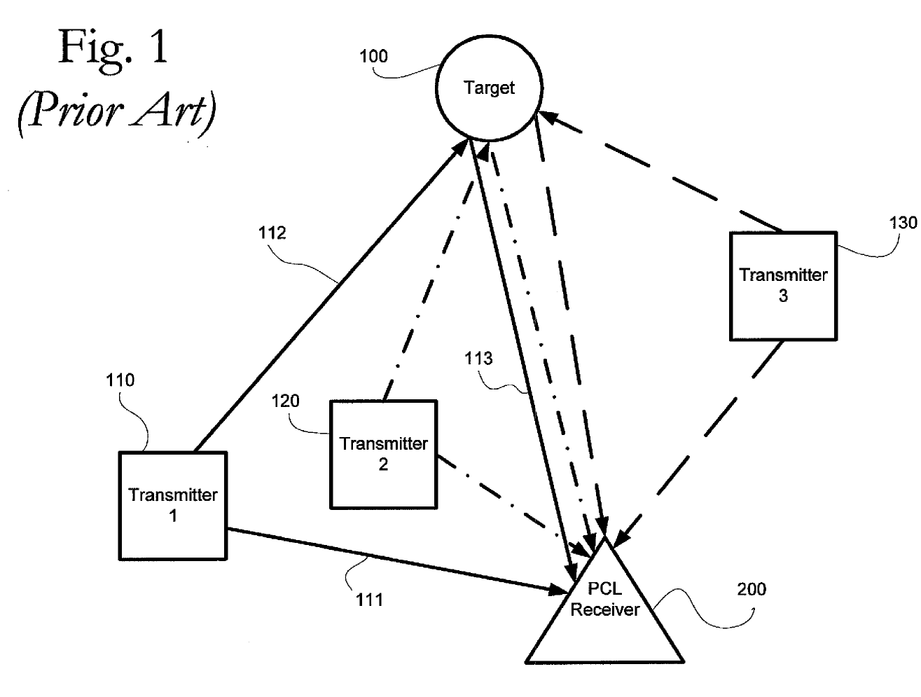

Each PCL processing unit 221-X identifies the direct path signal 223-X (e.g., direct path signal 111, FIG. 1). The direct path signal may be acquired from a dedicated antenna or may be determined from the filtered signals input to the PCL processing unit 221-X before processing by the parametric estimation bank 222-X.

The isolated direct path signal 223-X is fed into the parametric estimation bank 222-X. The parametric estimation bank 222-X has parametric estimators for each physical channel 210-i that provides a signal corresponding to the frequency channel the PCL processing unit 221-X is processing.

Each parametric estimator in the parametric estimation bank 222-X provides estimates of signal properties. Such signal properties may include, for example, frequency-difference of arrival (FDOA), time-difference of arrival (TDOA), and angle-of-arrival estimates for each target. These estimates are based on the signal scattered from targets (contained in the band-pass filtered signal) and the direct path signal 223-X.

The signal properties determined by each parametric estimator in the parametric estimation bank 222-X are provided to the parameter estimator 228-X. The parameter estimator estimates a target state, which may include, for example, a target's rectangular cross section, position, trajectory (bearing), speed, acceleration, type, and the like.

The target state is provided to output device 250 which may present a representation of the target states. Output device 250 may perform post processing to present a cohesive representation of the theater of operation including targets. Various estimation techniques, as are known in the art, may be used to resolve discrepancies of target properties estimated independently of on another. In some embodiments, output device 250 provides a visual display of the theater of operation. The theater of operation may for example, be the region in space where targets are being detected. In some embodiments, output device may also receive information from other intelligence systems (e.g., satellite imagery, additional radar systems) and provide a display to convey the totality of intelligence.

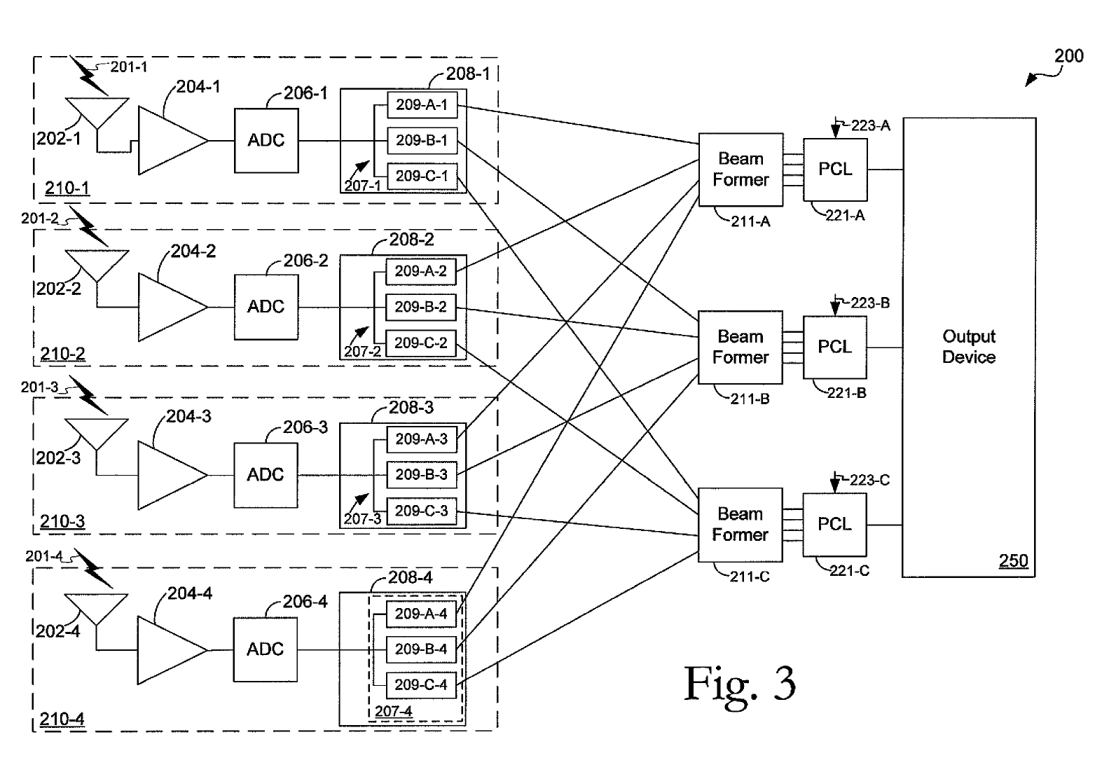

In some embodiments, beam forming may be used to isolate targets and/or direct path transmissions. FIG. 3 provides an embodiment of the PCL radar system 200 system where beam forming is used. Beam formers 211-X (X=A, B, C) may be added to the PCL radar system 200 in between the frequency channelizers 208-i and PCL processing units 221-X to perform digital beam forming. Each frequency channel's beam former 211-X beam forms the corresponding digital signals output from the physical channels. Any suitable beam forming techniques may be used (e.g., amplitude monopulse, adaptive beam forming). Beam forming techniques may uniquely alter each input signal by amplitude scaling, phase shifting, time shifting, and the like. When the beam formed signals from each antenna element are combined, the receiver may have sensitivity in a predetermined direction (e.g., the direction of a target) and reduced sensitivity in another direction (e.g., direction of direct path signal),

In some embodiments, multiple beam formers may be used simultaneously for each frequency channel to individually isolate target signals and the direct signal path. For example, a first beam former for a frequency channel may isolate the direct path signal, and a second beam former for the frequency channel may isolate a target signal. In some embodiments, time slots are used by beam former 211-X to beam form for multiple targets and/or sources.

The PCL processing units 322-X receives the beam formed signals from each physical channel individually from the corresponding beam former 211-X.

### Further Details for PCL Radar System 300

Having generally described some embodiments of the PCL radar system 200 with reference to FIGS. 2 and 3, greater detail is now provided with respect to the system's capabilities and embodiments of the system's components.

The transmitters (e.g., transmitters 110, 120, 130 in FIG. 1) used by PCL radar system 200 are not limited to TV and FM radio transmitters but may include national weather service transmitters, radio navigational beacons (e.g., VOR), transmitters supporting current and planned services and operations (e.g., automatic dependant surveillance-broadcast, cellular telephone transmitters, or any other suitable device transmitting electromagnetic waves. Transmitters may or may not be under operational control of the entity controlling the PCL radar system. The PCL radar system may be equipped to automatically select a subset of a plurality of usable transmitters. Transmitter locations may be determined any suitable way. For example, satellite imagery may be used to determine a transmitter's location.

The antenna array described above may consists of a plurality of antenna elements 202-i. The antenna elements may be dipole antennas, linear antennas, phased arrays, dish antennas, or any of many other suitable antenna designs. The antenna elements need not be of the same type.

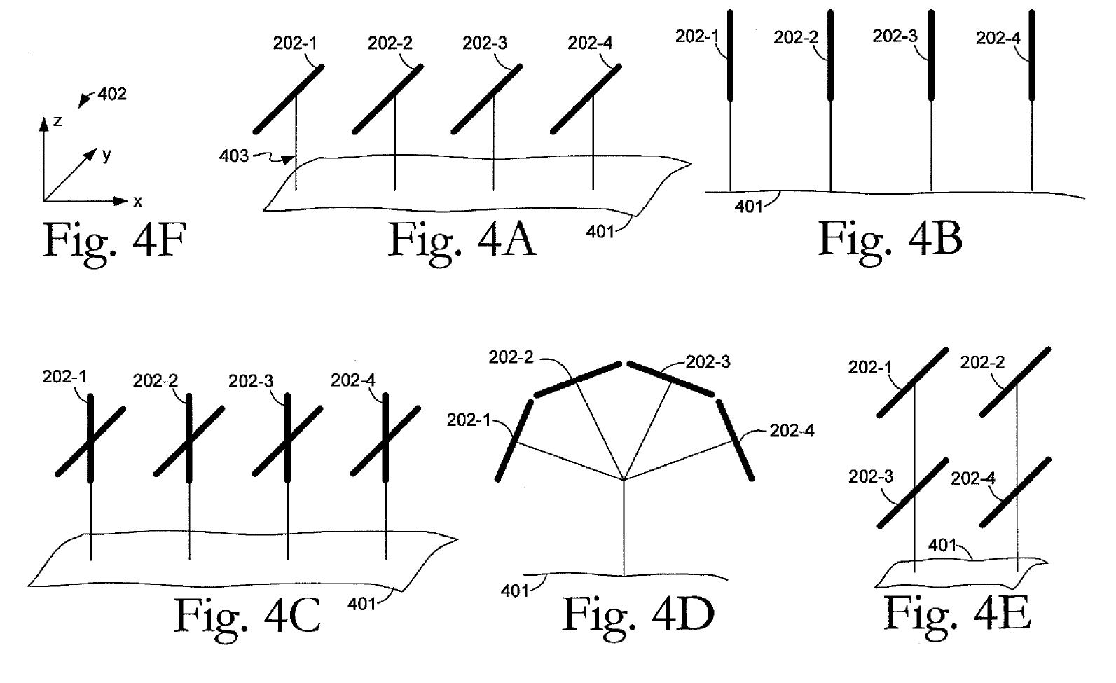

The antenna elements may be arrange in any suitable manner. FIGS. 4A-4E show various example arrangements of the antenna elements. In these drawings, antenna elements 302-i are shown as linear antennas, however, any combination of suitable antennas may be used in these or other configurations.

FIG. 4A show a perspective view of an antenna array such that the surface 401 is nominally in the XY plane defined by coordinate system 402 in FIG. 4F. Surface 401 may, for example, represent the surface of the earth or a deployment platform. Specifically, FIG. 4A shows a linear array of antennas arranged horizontally relative the surface 401. Any type of mechanical support structure 403 may be used in the construction.

In FIG. 4B the antenna elements 202-i are arranged in a vertical configuration.

FIG. 4C shows a perspective view of an antenna array such that the surface 401 is nominally in the XY plane defined by coordinate system 402 in FIG. 4F. The antenna elements include both vertical an horizontal components. In the illustrated embodiment, the horizontal and vertical components are both associated with the same antenna element. In some other embodiments the vertical and horizontal components may be distinct antenna elements that independently provide RF output signals.

As yet another example of an antenna array configuration, FIG. 4D shows an example where the antenna elements are arranged in a squinted configuration; each antenna stares in a different azimuth direction.

FIG. 4E provides an example of an elevated antenna configuration. A configuration of four antenna elements arranged in a rectangular grid is shown. Any suitable grid pattern or suitable layout of antenna elements may be used. Here horizontal linear antennas are depicted although any suitable type, orientation, or configuration of antennas may be used.

In some embodiments, ADC 204-i is an Advanced Digital Receiver Processor (ADRP™) manufactured by Lockheed Martin Corporation. The ADRP may also serve as the frequency channelizer. In some embodiments, the ADC is capable of A/D conversion of 512 MHz baseband signals.

In some embodiments, an analog front end is used to up mix to an intermediate frequency. In some embodiments the intermediate frequency is up to 1152 MHz.

The frequency channelizers 208-i each have a filter bank 207-i having a number of band-pass filters. The pass-band filters may be of any suitable configuration. Each filter may have any suitable band-pass shape (amplitude and phase) and the relationship between the filters (e.g., spectral spacing) may take any suitable form. The band-pass filters may be tunable as a group or independently tunable. Tuning alters a filters transfer function. The transfer function may be defined by a center frequency and a bandwidth. In some embodiments, the band-pass filters each have independently adjustable bandwidths and/or center frequencies. In some embodiments, the pass-bands of the pass-band filters in a filter bank are spectrally adjacent to on another. In some embodiments, the filters all have same bandwidth. Collectively, the filter bank may only cover a portion of the spectrum captured by the ADC. In some embodiments, the filter bank comprises 120 pass-band filters each having 2 MHz spacing. In some scenarios, multiple band-pass filters may correspond to a single transmitter.

The PCL processing unit 221-X may provide target state estimates for each target based on the information available within one or more frequency channels. A target's state may define the target's rectangular cross section, position, trajectory (bearing), speed, acceleration, type, and other properties of the target.

Line tracking may be used to track the return from a target over time. Line tracking may be used to reduce and reject false target identifications (false alarms).

The components of the PCL radar system 200 may be communicably coupled using any suitable technology. The components of the system need not be collocated. For example, components downstream of ADC 206-i may receive information via a digital communication network such as a fiber optic network, Ethernet, coaxial cable network, telephone, satellite, or any suitable digital communication technology.

Components may be implemented using software, hardware, or a combination of both. Some components may be implemented as digital signal processors (DSPs). Some components may be implemented in the same microprocessor (chip). Some components may be implemented as an application-specific integrated circuit (ASIC).

### Method 500

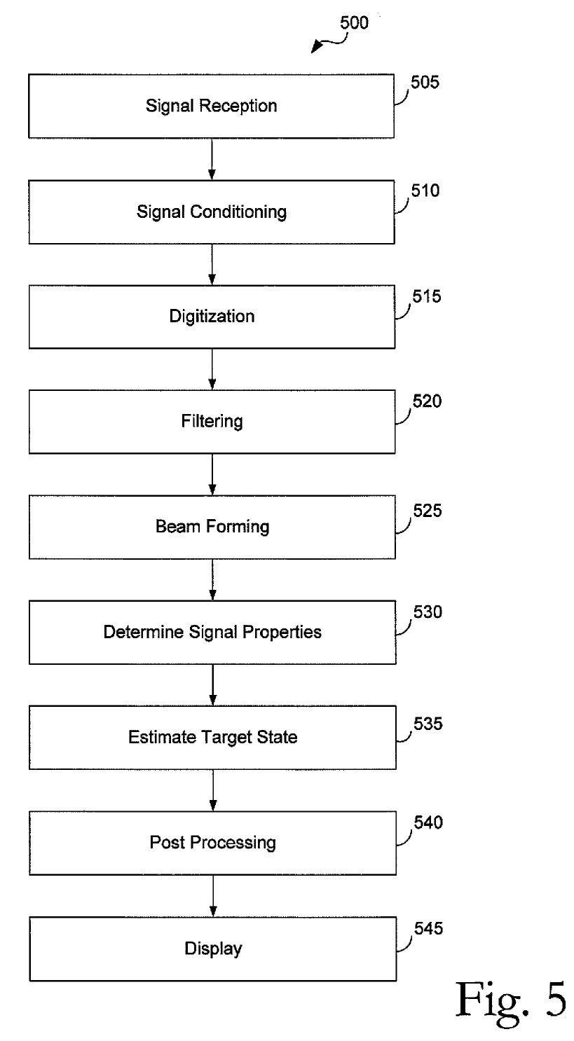

FIG. 5 provides a method 500 for operating a PCL radar system. Method 500 may be used, for example, to operate PCL radar system 200.

In step 505, RF signals are received on each of a plurality of antenna elements. The antenna elements may form an antenna array. Each antenna element corresponds to a unique physical channel.

In step 510, signal conditioning is performed on each physical channel to each RF signal. Conditioning may include selectively amplifying the RF signal. The signal conditioner may optionally perform analog band-pass filtering, or channel equalization to improve the quality of the reference signal.

In step 515, the RF signals of each physical channel is digitized. The RF signals may be digitized by an ADC such as ADC 206-i in PCL radar system 200 (FIGS. 2 and 3).

In step 520, the RF signals of each physical channel are digitally filtered by a filter bank. The filter bank may be part of a frequency channelizer such as frequency channelizer 208-i. The filter bank may comprise a plurality of band-pass filters. The pass-band filters may be used to provide channel equalization or conditioning as well as bandwidth reduction. A signal is output from each band-pass filter the filter bank.

Thus for each physical channel there may be multiple band-pass filtered output signals. The band-pass filters of one physical channel may each have a similar frequency response as a corresponding band-pass filter in each of the other physical channels. A frequency channel is shared by the output signals of a set of band-pass filters having a common frequency response but residing in distinct physical channels.

In step 525, beam forming is performed for each frequency channel on the band-pass filtered output signals originating from each physical channel corresponding the same frequency channel.

In step 530, signal properties are determined. The signal properties are determined from the filtered, and optionally beam formed, frequency channelizer output signals. For example, signal properties may include FDOA, TDOA, and angle-of-arrival information.

In step 535, the target state is estimated. The target state may include information such as the target's rectangular cross section, position, trajectory (bearing), speed, acceleration, type, and the like.

In step 540, post processing is performed to present a cohesive representation of the theater of operation. Discrepancies of the estimates of a target's state from the various channels may be resolved. Various estimation techniques, as are known in the art, may be used to resolve discrepancies in the target state estimated independently of on another.

In step 545, the target scenario is presented. For example, the target scenario may be displayed on a display as is known in the art.

The steps of method 500 may be performed in any suitable order or any suitable way. In some embodiments, each component continuously processes an inflowing stream of data.

In some other embodiments, data is sampled for a period of time and then processed. For example, such an embodiment may be used if the data rate of A/) conversion exceeds the processing speed of the down stream components.

Having thus described at least one illustrative embodiment of the invention, various alterations, modifications, and improvements will readily occur to those skilled in the art. Such alterations, modifications, and improvements are intended to be within the scope of the invention. Accordingly, the foregoing description is by way of example only and is not intended as limiting. The invention is limited only as defined in the following claims and the equivalents thereto.

What is claimed is:

1. A passive coherent location radar comprising:
a plurality of antenna elements, each antenna element to output an RF signal;
a plurality of analog-to-digital converters, each analog-to-digital converter configured to receive the RF signal from a corresponding antenna element among the plurality of antenna elements, and output a digital signal, the digital signal being a digital version of said RF signal; and
a plurality of frequency channelizers, each frequency channelizer having a plurality of digital band-pass filters and configured to receive the digital signal from a corresponding analog-to-digital converter among the plurality of analog-to-digital converters, input the digital signal to each of the plurality of digital band-pass filters, and output a plurality of filtered signals, each filtered signal output from a digital band-pass filter among the plurality of digital band-pass filters.

2. The passive coherent location radar of claim 1, further comprising a plurality of conditioning circuits, each conditioning circuit configured to amplify at least a portion of the RF signal output from a corresponding antenna element among the plurality of antenna elements prior to digitization of the RF signal by the corresponding analog-to-digital converter.

3. The passive coherent location radar of claim 1, wherein a predetermined passband is common to a predetermined digital band-pass filter among the plurality of digital band-pass filters in each of the plurality of frequency channelizers.

4. The passive coherent location radar of claim 3, further comprising:
a beam former configured to receive a filtered signal from each of the plurality of frequency channelizers, each filtered signal filtered by the predetermined digital band-pass filter in each respective frequency channelizer.

5. The passive coherent location radar of claim 3, farther comprising:
a processing unit having inputs to receive a filtered signal from each of the plurality of frequency channelizers, each filtered signal filtered by the predetermined digital band-pass filter in each respective frequency channelizer, and configured to estimate a frequency-difference of arrival.

6. The passive coherent location radar of claim 5, wherein the processing unit is further configured to estimate a target state.

7. The passive coherent location radar of claim 6, wherein the target state includes a target position and a target speed.

8. The passive coherent location radar of claim 1 wherein a first passband associated with a first digital pass-band filter among the plurality of digital band-pass filters in a frequency channelizer among the plurality of frequency channelizers, and a second passband associated with a second digital pass-band filter among the plurality of digital band-pass filters in said frequency channelizer are spectrally adjacent.

9. The passive coherent location radar of claim 1, wherein each of the plurality of analog-to-digital converters has a Nyquist frequency greater than or equal to 500 MHz.

10. The passive coherent location radar of claim 1, wherein the plurality of antenna elements are arranged in a linear configuration.

11. A method of operating a passive coherent location radar system, the method comprising:
receiving an RE signal on each of a plurality of antenna elements, each antenna element corresponding to a physical channel;
digitizing each RF signal;
filtering each digitized RF signal with a plurality of digital band-pass filters, each digital band-pass filter corresponding to a frequency channel;
determining a frequency-difference of arrival (FDOA) with respect to a corresponding reference signal for each filtered signal; and
estimating a target state from the corresponding FDOA from each physical channel for each frequency channel.

12. The method of claim 11, further comprising:
beam forming the filtered signals of a predetermined frequency channel from each physical channel.

13. The method of claim 11, further comprising:
amplifying at least one RF signal prior to digitization.

14. The method of claim 11, wherein:
the plurality of digital band-pass filters used for filtering form a filter bank; and
each digitized RF signal is filtered with identical filter banks.

15. The method of claim 11, wherein the estimated target state includes a target position and target velocity.

16. A radar system comprising:
a physical channel comprising:
an antenna configured to output a received RF signal;
an amplifier configured to amplify at least a portion of the RF signal;
an analog-to-digital converter configured to digitize the amplified RF signal; and
a digital filter bank comprising a plurality of pass-band filters configured to receive the digitized RF signal and output a plurality of digital band-passed signals; and
a processing unit configured to receive a digital band-passed signal, from the plurality of digital band-passed signals, output from a pass-band filter among the plurality of pass-band filters and estimate a target state.

17. The radar system of claim 16, wherein the physical channel, antenna, RF signal, analog-to-digital converter, digital filter bank, plurality of pass-band filters, digital band-passed signal, plurality of digital band-passed signals, and pass-band filter are a first physical channel, first antenna, first RF signal, first analog-to-digital converter, first digital filter bank, first plurality of pass-band filters, first digital band-passed signal, first plurality of digital band-passed signals, and first pass-band filter, respectively, the radar further comprising:
a second physical channel comprising:
a second antenna that outputs a second RF signal;
a second amplifier configured to amplify at least a portion of the second RF signal;
a second analog-to-digital converter configured to digitize the amplified second RF signal; and
a second digital filter bank comprising a second plurality of pass-band filters configured to receive the digitized second RF signal and output a second plurality of digital band-passed signals,
wherein, the processing unit is further configured to receive a second digital band-passed signal, from the second plurality of digital band-passed signals, output from a second pass-band filter among the second plurality of pass-band filters.

18. The radar system of claim 17, wherein the first pass-band filter of the first plurality of pass-band filters and the second pass-band filter of the second plurality of pass-band filters have a same filtering characteristic.

19. The radar system of claim 16, further comprising:
a beam former configured to modify the first digital band-passed signal in accordance with a beam forming technique, prior to reception of said signals by the processing unit.

20. The radar system of claim 16, wherein the target state includes a target position and target velocity.
